(19) United States
(12) Patent Application Publication
(10) Pub. No.: US 2004/0157028 A1
(43) Pub. Date: Aug. 12, 2004

(54) Adhesive tape for protecting, labeling, insulating and sheathing

(75) Inventors: Dieter Wenninger, Singapore (SG); Petrus Sentosa, Singapore (SG); Michael Cheong, Singapore (SG)

Correspondence Address: Norris, McLaughlin & Marcus P.A., 30th Floor, 220 East 42nd Street, New York, NY, 10017, US

(73) Assignee: tesa Aktiengesellschaft, Hamburg (DE)

(21) Appl. No.: 10/733,078

(22) Filed: Dec. 11, 2003

(30) Foreign Application Priority Data
Dec. 18, 2002 (DE) 102 59 618.2

(51) Int. Cl. B32B 9/00

(52) U.S. Cl. 428/40.1

(57) ABSTRACT

Adhesive tape composed of a sheet based on plasticized polyvinyl chloride and an adhesive dispersion based on styrene-acrylic acid derivative copolymers, comprising plasticizers which have migrated from the sheet into the adhesive.

The invention relates to an adhesive tape composed of a sheet based on plasticized polyvinyl chloride and an adhesive based on an aqueous dispersion of styrene-acrylate copolymers which is used, for example, for wrapping ventilation lines in air conditioning units, or wires or cables and which is suitable in particular for cable harnesses in vehicles or field coils for picture tubes. The purpose of the adhesive tape here is for bundling, insulating, marking, sealing or protecting.

### BACKGROUND OF THE INVENTION

Electrical and electromechanical components, and the sheathing of electrical leads, are in many cases composed of polymeric materials, with polyvinyl chloride (PVC) representing the most important plastic, owing historically to its availability and to its excellent materials properties and insulating properties.

The standard thickness of the PVC sheets for winding tapes is from 85 to 200 μm. Below 85 μm considerable problems occur during production in the calendering operation, with the consequence that hardly any PVC sheets for winding tapes with a thickness below 85 μm are available. This applies equally to winding tapes with a reduced PVC content.

Winding tapes based on plasticized PVC sheets are used in cars for bandaging electrical leads to form cable harnesses. Although at the start of their technical development the primary purpose of using these winding tapes, developed originally as insulating tapes, was to improve the electrical insulation, it is now necessary for cable loom tapes of this kind to fulfil additional functions, such as the bundling and durable fixing of a multiplicity of individual cables to form a stable cable strand and also the protection of the individual cables and of the cable strand as a whole against mechanical, thermal and chemical damage.

Attempts are made to use wovens or nonwovens instead of plasticized PVC sheet. In practice, however, the resultant products are little used, since they are relatively expensive and differ greatly from the habitual products in handling (for example hand tearability, elastic resilience) and under service conditions (for example resistance to service fluids, electrical properties), and in this context particular importance is accorded to the thickness, as set out below.

Sheaths of copper wires in particular are composed predominantly of PVC, unless conditions such as high-temperature requirements force alternatives.

In the past, self-adhesive tapes were developed for the mechanical and electrical protection of such cables, the tapes in question being those as generally and extensively used for protecting and insulating, and bandaging, electrical leads and components.

The self-adhesive tapes allow a long-term union to be produced without damage occurring to the cable as a result of interactions between adhesive tape and cable sheathing. The additives in the plasticized PVC, in particular, tend to migrate, and necessitate adhesive tapes tailored specifically to such materials.

Therefore, adhesive tapes having a PVC sheet backing, in particular, have become established: firstly on account of their mechanical properties, but secondly on account of minimized compatibility problems as well, since at least backing and substrate are composed of the same material.

State of the art for the bandaging of sets of leads are adhesive tapes with or without an adhesive coating which are composed of a PVC backing material made flexible by incorporating considerable amounts (from 30 to 40% by weight) of plasticizer. The backing material is usually coated on one side with a self-adhesive composition based on SBR rubber and natural rubber. JP 10 001 583 A1, JP 05 250 947 A1, JP 2000 198 895 A1 and JP 2000 200 515 A1 describe typical plasticized PVC adhesive tapes.

PVC in the absence of plasticizer is a hard, brittle plastic in the processed state at room temperature. In many cases, however, a PVC material which is flexible and stretchable is needed at 20° C. or below. This requirement is achieved by means of internal or external plasticizers.

In the former case the monomeric vinyl chloride is copolymerized with a component which, as a yielding interlink, gives the resultant polymer its flexibility. An advantage of these internal plasticizers is that these “plasticizers” are unable to migrate into the adhesive and are not volatile and so do not initiate any unwanted secondary reactions. A disadvantage is that desired properties of the sheets can only be influenced inadequately even by the sheet manufacturer; another disadvantage is the markedly higher price. The consequence of both these disadvantages is that, among adhesive tape manufacturers,

PVC sheets without internal plasticizer have become established. PVC sheets for the adhesive tape sector are produced using external plasticizers. By external plasticizers are meant the admixing of plasticizers to the PVC. As a result the material loses its brittleness, and becomes soft, flexible and stretchable. A further result of the addition of plasticizers is a drop in the transition temperature; in other words, the thermoplastic undergoes transition from the hard elastic state to the soft elastic state at lower temperatures. Plasticizers can also be regarded as solvents for PVC. The plasticizer molecules insert themselves between the PVC macromolecules, thereby increasing their mobility.

The plasticizer is held between the PVC molecules predominantly by means of dipole forces. Accordingly the majority of plasticizers come from the class of the esters of organic acids (for example phthalic acid, adipic acid) and are used mostly in the range between 25% and 60% by weight. The best-known plasticizer for PVC in the adhesive tape industry is dioctyl phthalate (DOP), which is distinguished by its universal applicability, high volatility and strong migration. Besides the monomeric plasticizers described, plasticizers on a polymeric basis are also used. These are generally esters based on organic acids and polyhydric long-chain alcohols. These polymeric plasticizers are noted on the one hand for a relatively low migratability from the sheet into the adhesive and on the other hand by relatively low outgassing.

Monomeric plasticizers of conventional insulating tapes and cable winding tapes are subject to gradual evaporation, leading to a burden on health; the commonly used DOP, in particular, is objectionable. Moreover, in motor vehicles, the vapours are deposited on the glazing, which impairs visibility (and hence driving safety, considerably) and is referred to by the skilled worker as fogging (DIN 75201). In the event of even greater evaporation owing to higher temperatures, for example in the engine interior of vehicles or in electrical appliances in the case of insulating tapes, the tape undergoes embrittlement as a result of the loss of plasticizer which occurs.

If plasticized PVC comes into contact with another plastic, for example adhesive, then it is possible for the plasticizer to migrate to that plastic. The migration of the plasticizer into the adhesive layer generally has an adverse effect on the adhesive, since important technical adhesive properties, such as bond strength and cohesion, are greatly impaired in this case.

Different plasticizers migrate differently. Monomeric plasticizers are notable essentially for very severe migration, whereas polymeric-based plasticizers exhibit plasticizer migration to a lesser degree. The unwanted effect of plasticizer migration is normally manifested to a particularly severe extent when water-based adhesives are used. Here there is a distinct reduction in the bond strength and cohesion following storage in the case of conventional aqueous adhesives, such as acrylate dispersions, for example. These adhesive tapes are then only of limited usefulness as adhesive tape.

Although adhesive tapes based on plasticized PVC in conjunction with aqueous adhesives (acrylate dispersions) are known, only a small plasticizer fraction can be used, in order to avoid the aforementioned negative effects on the technical adhesive properties. Furthermore, these adhesive tapes do not meet detailed automotive specifications. The technical adhesive properties of such adhesive tapes are markedly impaired as a result of the migration of the plasticizer into the adhesive. At higher concentrations the adhesive tape is unsuitable for use, owing to inadequate bond strength and cohesion.

These plasticizers therefore require precisely tailored adhesive systems. In order to be able to use a suitable adhesive tape system it is necessary for the adhesive to buffer the uptake of plasticizers or it is necessary for the migration of the plasticizers to be used actually to obtain a suitable technical adhesive profile.

The use of aqueous adhesives with relatively higher plasticizer concentrations, or the use of plasticizers for setting adhesive properties in the case of aqueous adhesives, is unknown.

For the field of use of cable winding tapes a long-term test over 3,000 hours, in accordance for example with FORD specification S95 GG 14K 024 BA, has become established as a standard test. Specimen cable harnesses are stored at the test temperatures and, after fixed periods of time, generally every 500 hours, are bent around a mandrel of defined diameter and subsequently examined for damage; this test runs over a total period of 3,000 hours. Besides purely visual inspection, in some cases there is also an electrical insulation test. The test temperatures are guided by the fields of use of the cable looms and amount, for example, to 90° C. for woven tapes employed in the passenger compartment, according to FORD S95 GG 14K 024 BA. For applications within the engine compartment, sustained temperatures of 125° C. and higher are specified as well.

Aqueous systems based on styrene-acrylate copolymers are known and on account of their resistance properties to water and mechanical abrasion and their flexibility are used for the building sector, for floor coverings and seals, for example. In the adhesive tape sector, the materials are unknown as starting materials for adhesive. Depending on the styrene fraction of the copolymers the materials differ in hardness, the styrene fraction normally used being between 30% and 60%. Films of styrene-acrylate copolymers, coated out onto hard, plasticizer-free substrates, display no self-adhesive properties at all, such as bond strength or tack.

It is an object of the present invention to provide an adhesive tape comprising a sheet based on plasticized PVC containing either polymeric and/or monomeric plasticizers and comprising a solventlessly prepared, aqueous adhesive based on acrylate-styrene copolymers, for which the adhesive properties can be adjusted by means of migration of plasticizer from the sheet into the adhesive so that the solvent-free, aqueous adhesive is suitable for sheets having high plasticizer concentrations.

The adhesive tapes ought also to meet the new Ford specification FORD S95 GG 14K 024 BA for use as an adhesive tape, for example, for the wrapping of ventilation lines in air conditioning units, or wires or cables, and ought to be suitable in particular for cable harnesses in vehicles or field coils for picture tubes.

### SUMMARY OF THE INVENTION

The present invention accordingly provides a single-sidedly self-adhesive tape comprising a sheet based on plasticized PVC and an adhesive based on an aqueous dispersion of styrene-acrylate acid derivative copolymers comprising plasticizers which have migrated from the sheet into the adhesive.

As a result of the migration of the plasticizers from the sheet into the adhesive, self-adhesive properties are achieved and set in the adhesive.

### DETAILED DESCRIPTION

Sheets which can be used with advantage in accordance with the invention include plasticized PVC sheets comprising polymeric plasticizers, such as esters of phthalic acid, adipic acid or phosphoric acid and polyhydric alcohols, for example, and also monomeric plasticizers, such as DOP, TOTM or DIDP for example.

In one preferred embodiment of the invention the sheets of the invention are produced by means of a calendering operation.

The thicknesses of the plasticized PVC sheets are preferably between 50 and 200 μm, in particular between 70 and 180 μm.

In one preferred embodiment of the invention, situated between the sheet based on plasticized PVC and the adhesive layer, there is an adhesion promoter which is able greatly to enhance the effective union of the adhesive with the sheet.

With further advantage there is a reverse-face coating on the side of the sheet remote from the adhesive side, which ensures ease of unwinding.

The application rate of the adhesive layer is in particular 10 to 50 g/m². In one preferred variant the application rate set is from 13 to 40 g/m², more preferably from 15 to 35 g/m².

For the skilled worker it is surprising that these films, even where high plasticizer concentrations of up to 40% by weight are used, can be employed in conjunction with the aqueous adhesives described. The skilled worker would normally expect a distinct deterioration in the technical adhesive properties of the adhesive to result from the migration of the plasticizer into the adhesive.

In the case of the adhesive tapes of the invention, in contrast, the dispersion based on acrylic acid derivative-styrene copolymers is used, which becomes self-adhesive by virtue of migration of the plasticizer or plasticizers from the plasticized PVC sheet into the adhesive. The adhesive properties can be adjusted according to the plasticizer concentration and temperature treatment of the adhesive tapes.

It is in accordance with the invention here to use acrylic acid derivative-styrene copolymers with a styrene fraction of from 10 to 70%. One particularly preferred version uses acrylic acid derivative-styrene copolymers with a styrene fraction of from 20 to 65%.

Also in accordance with the invention is the use of blends with acrylic acid derivative-styrene copolymers with at least one resin dispersion based on hydrocarbon resins, rosins (rosin ester) or terpene phenolic resins. The fraction of the resin dispersion can amount to up to 50% by weight.

In a second preferred embodiment it is possible to mix in acrylate dispersions and also styrene-butadiene copolymer dispersions. The fraction of the resin dispersions and/or of the acrylate dispersions can in this case amount to up to 60% by weight.

Likewise in accordance with the invention is the use of blends of acrylic acid derivative-styrene copolymers with oils, with oil emulsions and/or with polymeric or monomeric plasticizers in order to “fine-tune” the adhesive. The fraction of the oil component and/or plasticizer component can in this case amount to up to 40% by weight.

The adhesive is preferably crosslinked by chemical, thermal or radiation treatment.

The adhesive can be admixed with the antifoams, ageing inhibitors and wetting agents that are familiar to the skilled worker, in order to optimize its properties.

The adhesive tapes of the invention can be produced in accordance with the known methods. An overview of customary production methods can be found, for example, in “coating equipment”, Donatas Satas in “Handbook of Pressure Sensitive Adhesive Technology”, Second Edition edited by Donatas Satas, Van Nostrand, New York, pp. 708 to 808. The known methods of drying and slitting the adhesive tapes are likewise to be found in the Handbook.

The adhesive tapes of the invention are suitable for a large number of winding applications.

Accordingly, the winding sheets of the invention are used, for example, for wrapping ventilation lines in air conditioning units, or wires or cables, and are suitable in particular for cable harnesses in vehicles or field coils for picture tubes. In these utilities the adhesive tape serves for bundling, insulating, marking, sealing or protecting.

1. Adhesive tape comprised of
a sheet of plasticized polyvinyl chloride and
an adhesive dispersion of styrene-acrylic acid derivative copolymers, comprising plasticizers migrated from the sheet into the adhesive.

2. Adhesive tape according to claim 1, wherein the styrene fraction of the adhesive is from 10% to 70%.

3. Adhesive tape according to claim 1, wherein the adhesive is applied to the polyvinyl chloride sheet in an amount of from 10 to 50 g/m².

4. Adhesive tape according to claim 1, wherein the sheet has a thickness of between 50 and 200 μm.

5. Adhesive tape according to claim 1, wherein the adhesive layer contains up to 50% by weight of at least one resin dispersion based on hydrocarbon resins, rosin esters or terpene-phenolic resins.

6. Adhesive tape according to claim 1, wherein the adhesive layer contains up to 60% by weight of at least one dispersion based on styrene-butadiene copolymers or acrylate dispersions.

7. Adhesive tape according to claim 1, wherein the adhesive layer contains up to 40% by weight of at least one monomeric or polymeric plasticizer or oil.

8. Adhesive tape according to claim 1, wherein a layer of a primer is applied between the sheet and the adhesive layer.

9. Adhesive tape according to claim 1, wherein a release layer is applied on the side of the sheet remote from the adhesive side.

10. Adhesive tape according to claim 1, wherein the adhesive is crosslinked by chemical, thermal or radiation treatment.

11. Adhesive tape according to claim 1, wherein the adhesive comprises antifoams, ageing inhibitors and wetting agents.

12. A method of bundling, protecting, labelling, insulating or sealing ventilation pipes or wires or cables which comprises bundling, protecting, labelling, insulating or sealing the same with an adhesive tape of claim 1.

13. A method of sheathing cable looms in vehicles or field coils for picture tubes which comprises sheathing same with an adhesive tape of claim 1.
